(19) United States
(12) Patent Application Publication
(10) Pub. No.: US 2025/0343035 A1
(43) Pub. Date: Nov. 6, 2025

(54) Pressure Based OPI Position Control

(71) Applicant: DH Technologies Development Pte. Ltd., Singapore (SG)

(72) Inventors: Thomas R. COVEY, Newmarket (CA); Peter KOVARIK, Markham (CA); Chang LIU, Richmond HIll (CA); Erik MILLER, Belchertown, MA (US)

(73) Assignee: DH Technologies Development Pte. Ltd., Singapore (SG)

(21) Appl. No.: 19/128,271

(22) PCT Filed: Nov. 2, 2023
(86) PCT No.: PCT/IB2023/061068

§ 371 Date: May 8, 2025

Related U.S. Application Data
(60) Provisional application No. 63/424,325, filed on Nov. 10, 2022.

(51) Int. Cl. H01J 49/04

(52) U.S. Cl. CPC H01J 49/0404

(57) ABSTRACT

In one aspect, a method of positioning an open end of an open port interface (OPI) relative to a sample surface to be analyzed by mass spectrometry is disclosed. The OPI includes a liquid delivery conduit for delivering a liquid to the open end of the OPI and a liquid exhaust conduit for removing liquid from the open end of the OPI. The method includes establishing a fluid flow along a path extending from the liquid delivery conduit to the open end of the OPI, monitoring fluid pressure at one or more locations along the fluid flow path and adjusting a position of the open end of the OPI relative to the sample surface based on the monitored fluid pressure. The fluid can be a gas or a liquid. Further, the sample surface can be a liquid surface or a solid surface.

### RELATED APPLICATIONS

This application claims priority to U.S. Provisional Application No. 63/424,325 filed on Nov. 10, 2022, the contents of which are incorporated herein in their entirety.

### TECHNICAL FIELD

The present disclosure relates to methods and systems for performing mass spectrometry and in particular to such methods and systems in which an open port interface (OPI) is employed for introducing a sample into a mass spectrometric system for analysis.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

Open-port interface (OPI) is an MS sampling device that captures, mixes, and dilutes a sample for which mass analysis is desired with a carrier fluid for delivery to an ion source of the mass spectrometer. Since its introduction, OPI has been used as a universal interface for introduction of samples into a variety of ion sources, such as ESI (electrospray ionization) and APCI (atmospheric pressure chemical ionization) ion sources for analysis of samples in a variety of applications including direct sampling of tissues, particles generated by laser ablation, SPME fibers, magnetic particles, aerosols, and discrete liquid droplets with volumes in the nanoliter and microliter ranges.

Using a tethered-OPI to form a liquid-junction contact with a solid or a liquid sample surface is one important class of OPI applications. For such sampling processes, the control of the relative position between the OPI and the sample surface is critical. For example, the liquid junction would not form if the distance between the OPI and the sample surface is too large. On the other hand, OPI/sample contamination could be a problem if the OPI is over positioned relative to the sample.

To address the above challenges, conventional methods for determining “contact” between an OPI and a sample surface rely on image capture and analysis, distance measurements using a laser beam, or conductivity measurements. These approaches, however, suffer from a number of shortcomings. For example, these position control approaches require the integration of additional components into the OPI (e.g., camera, laser generator, electrical circuit components, etc.), which result in added complexity and expense.

### SUMMARY

In one aspect, a method of positioning an open end of an open port interface (OPI) relative to a sample surface to be analyzed by mass spectrometry is disclosed. The OPI includes a fluid delivery conduit for delivering a fluid to the open end of the OPI and a liquid exhaust conduit for removing liquid from the open end of the OPI. The method includes establishing a fluid flow along a path extending from the fluid delivery conduit to the open end of the OPI, monitoring fluid pressure at one or more locations along the fluid flow path and adjusting a position of the open end of the OPI relative to the sample surface based on the monitored fluid pressure. The fluid can be a gas or a liquid. Further, the sample surface can be a liquid surface or a solid surface.

The method can further include identifying a target position of the open end of the OPI relative to the sample surface via identification of a predefined pressure variation, e.g., a pressure increase or decrease, in the monitored pressure. For example, the pressure signature indicating that a target position of the open end of the OPI relative to the sample surface has been achieved, e.g., a contact between the open end of the OPI and a sample surface has been established, can be an increase in the measured pressure of the delivered fluid. Such an increase in the pressure of the delivered fluid can be due to an increase in the outflow resistance caused by the sample surface, which upon contact with the open end of the OPI can provide blocking resistance to the fluid flow.

In some embodiments, a pump is utilized to establish the fluid flow. In some such embodiments, the pressure in the flow path is determined by measuring the pressure at the outlet port of the pump. By way of example, a pressure transducer incorporated in the pump can be utilized to perform the pressure measurement.

The step of adjusting the position of the open end of the OPI relative to the sample surface includes adjusting a distance between the open end of the OPI and the sample surface. By way of example, the predefined pressure variation includes a predefined increase in the measured pressure.

In a related aspect, a method of operating a dual-function open port interface (OPI) used in mass spectrometry is disclosed. The OPI can include a fluid delivery conduit for delivering a fluid to an open end thereof and a liquid exhaust conduit for removing liquid from the open end. The method includes operating the OPI in a sample-positioning mode by establishing a fluid flow along a fluid path extending from the fluid delivery conduit to the open end of the OPI, and monitoring fluid pressure at one or more locations along the fluid flow path. The monitored pressure can be used to identify contact between the open end of the OPI and a sample surface by detecting an expected pressure variation. Subsequently, the operation of the OPI can be switched into a sample-collection mode by establishing a transport liquid flow into the fluid delivery conduit for introducing one or more portions of the sample into the liquid exhaust conduit.

The method can further include registering the position of the open end of the OPI relative to the sample surface upon establishing contact between the open end of the OPI and the sample surface. Subsequently, the open end of the OPI can be retracted from the sample surface and the operational mode of the OPI can be switched to the sample-collection mode. The registered position of the open end of the OPI can then be utilized to re-establish contact between the open end of the OPI and the sample surface.

In some embodiments, the transport liquid or dedicated wash liquid can be used to wash one or more surfaces of the fluid delivery conduit and/or the liquid exhaust conduit prior/post to initiation of sample collection. The cleaning of these surfaces can remove, e.g., chemical residues deposited thereon during previous mass analysis experiments.

In a related aspect, a mass spectrometer is disclosed, which includes an open port interface (OPI) having a dual-mode functionality such that in one mode the OPI can be utilized for establishing contact between an open end thereof and a sample surface and in another mode the OPI can be utilized for collecting the sample via its open end, wherein the OPI is movable relative to the sample surface and wherein the OPI includes a fluid delivery conduit for delivering a fluid to the open end of the OPI and a liquid exhaust conduit for removing liquid from the open end of the OPI. The mass spectrometer further includes a pump for establishing a fluid flow along a path extending from the fluid delivery conduit to the open end of the OPI and a pressure transducer for monitoring fluid pressure at one or more locations along the fluid flow path and generating pressure measurement data. A controller can receive the pressure measurement data and process the data to identify a desired position of the open end of the OPI relative to the sample surface.

In some embodiments, the controller is configured to identify the desired position of the open end of the OPI relative to the sample surface via detection of a signature pressure increase in the pressure measurement data. By way of example, a pressure increase of at least 0.01%, or at least 0.1%, or at least 1% or at least 10% relative to a pressure measured prior to contact between the open end of the OPI and the sample surface can indicate that contact between the open end of the OPI and the sample surface has been established.

The pump can be fluidly coupled to a liquid reservoir, which stores a transport liquid, for causing flow of the liquid from the reservoir to the fluid delivery conduit via a fluid path. Further, the fluid path can include one or more actuable valves for selecting/controlling/regulating flow of fluid or the liquid from the liquid reservoir to the fluid delivery conduit. The controller can be operably coupled to the actuable valves for controlling opening and closing thereof. An OPI according to embodiments of the present teachings can be operated in two modes: (1) with liquid transport flow for sampling or (2) with a fluid flow (e.g., a gas or liquid) for positioning of the open end of the OPI relative to a sample surface/boundary (e.g., liquid level detection relative to a surface of a liquid sample). To switch between the two modes, the controller can be configured to cause the valve to close during positioning of the OPI relative to the sample surface so as to stop flow of the transport liquid to the OPI. Once contact is established between the open end of the OPI and the sample surface, the controller can cause the actuable valve(s) to open so as to initiate normal operation of the OPI for transfer of the sample to the ion source. The switch to the liquid transport flow may occur with the open end of the OPI above/outside liquid surface followed by re-establishing contact between the open end of the OPI and the liquid surface.

In a related aspect, a method of liquid-liquid extraction of a multi-phase liquid sample is disclosed, which comprises positioning an open end of an open port interface (OPI) relative to a top surface of the liquid sample, wherein said OPI comprises a fluid delivery conduit for delivering a fluid to the open end of the OPI and a liquid exhaust conduit for removing liquid from the open end of the OPI. A fluid flow, e.g., a gas flow, is established along a path extending from the fluid delivery conduit to said open end of the OPI, and the fluid pressure at one or more locations along said fluid flow path is monitored while moving the open end of the OPI relative to the top surface of the sample. The method further includes identifying contact between the open end of the OPI and the top surface of the sample, i.e., the liquid-air interface associated with an upper liquid layer of the sample, via detection of a predefined pressure change, and moving the open end of the OPI below the top surface of the sample while continuing to monitor the fluid pressure to detect a liquid-liquid interface between an upper liquid layer and a lower immiscible liquid layer via detection of another predefined pressure change, e.g., a change, such as an increase or decrease, of the slope of variation of pressure as a function of time (distance traveled by the open end of the OPI in the liquid as the OPI end is moved deeper into the liquid).

Subsequent to the detection of one or more liquid-liquid interfaces within the sample depth, the open end of the OPI can be adjusted to be within a liquid layer of interest (e.g., an aqueous or an organic layer) to extract samples of the liquid in that layer. By way of example, and without limitation, the multi-phase sample can include aqueous and organic liquid layers.

Further understanding of various aspects of the present teachings can be obtained by reference to the following detailed description and the associated drawings, which are described below.

### BRIEF DESCRIPTION OF THE DRAWINGS

FIG. 1A is a flow chart depicting various steps in one embodiment of a method according to the present teachings,

FIG. 1B is a flow chart depicting various steps in one example of implementation of a method according to the present teachings,

FIG. 2 schematically depicts an open port interface (OPI) according to an embodiment of the present teachings,

FIG. 3A schematically depicts a mass spectrometric system according to an embodiment of the present teachings,

FIG. 3B schematically depicts an example of communication between a controller employed in the embodiment of FIG. 3A with various components of the system,

FIG. 3C schematically depicts an embodiment of a mass spectrometric system according to an embodiment in which a single pump is utilized,

FIGS. 4A and 4B schematically depict that as the open end of the OPI is moved closer to the liquid surface the measured pressure remains substantially constant prior to contact between the open end of the OPI and the liquid surface,

FIGS. 4C and 4D schematically depict that the establishment of contact between the open end of the OPI and the liquid surface results in a detected increase in the measured pressure,

FIG. 5 provides a hypothetical fluid pressure at the output port of a pump delivering a fluid to the OPI fluid delivery conduit as a function of time as the open end of the OPI is moved relative to the sample surface, where the jump in the observed pressure indicates that contact between the open end of the OPI and the sample surface has been established,

FIG. 6 schematically depicts an example of implementation of a controller suitable for use in the practice of the present teachings.

FIG. 7A schematically depicts lowering the open end of an OPI into a liquid container that contains multiple different liquid layers,

FIG. 7B schematically depicts an example of a hypothetical pressure variation that may be observed as the open end of the OPI is lowered into the liquid, and

FIG. 7C shows an example of pressure variations that may be observed when an open end of an OPI is moved sequentially through a layer of air, a layer of methanol and a layer of water.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As used herein, establishing a contact between an open end of an OPI and a liquid surface or liquid boundary is intended to include both the establishment of an actual physical contact between the open end of the OPI and the liquid surface/boundary as well as positioning the open end of the OPI sufficiently close to the liquid surface/boundary such that it would lead to a detectable change in the monitored pressure, e.g., within a range of about 50 microns to about 5 millimeters relative to the liquid surface/boundary.

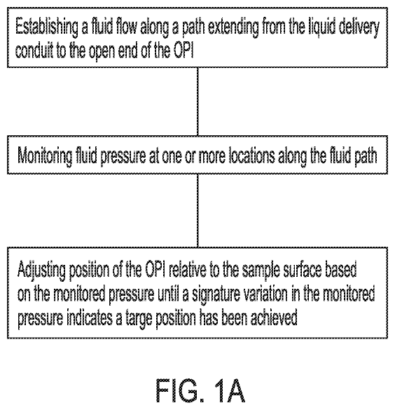

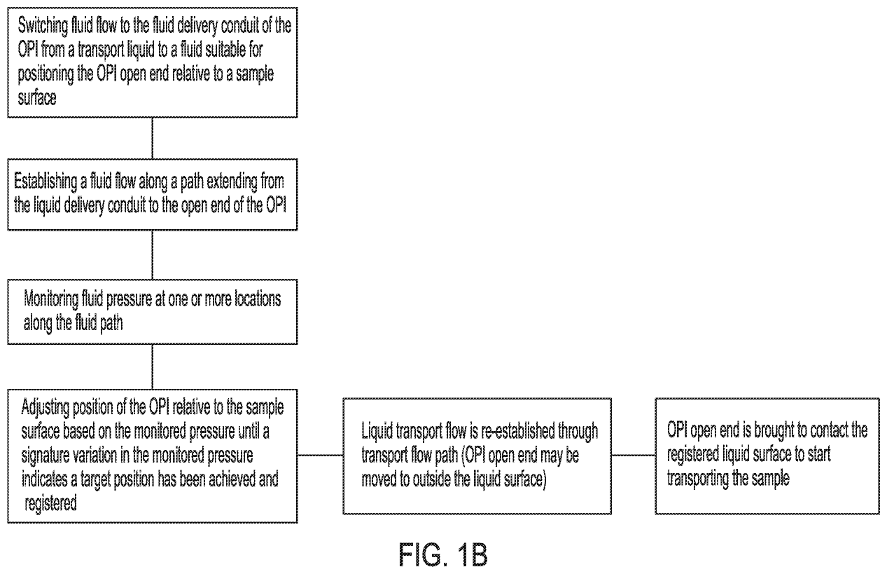

With reference to the flow chart of FIG. 1A, in one embodiment of a method according to the present teachings, an open end of an open port interface (OPI), which includes a fluid delivery conduit for delivering a fluid to the open end of the OPI and a liquid exhaust conduit for removing liquid from the open end of the OPI, can be positioned relative to a surface of a sample to be analyzed by mass spectrometry by establishing a fluid flow, typically a gas flow, such as the flow of air, along a path extending from the fluid delivery conduit to the open end of the OPI, monitoring fluid pressure at one or more locations along the fluid path, and adjusting a position of the open end of the OPI relative to the sample surface based on the monitored fluid pressure. The detection of a signature variation in the monitored pressure, e.g., the detection of a pressure spike, can indicate that a desired position of the open end of the OPI relative to the sample surface has been achieved, e.g., a contact has been established between the open end of the OPI and the sample surface.

In embodiments of the above method, the OPI flow path, which is normally used with a transport liquid to transport samples into an ion source, can be switched to deliver a gas to the open end of the OPI for facilitating the detection of a target sample surface, e.g., the liquid level of a liquid sample. For example, the flow path can be initially purged of any remaining liquid followed by the detection of the sample surface using a fluid (typically a gas). With the sample surface (e.g., the sample liquid level) detected and registered, the OPI open end can be retracted from the sample surface to re-start the transport liquid flow through the flow path. Once the flow of the transport liquid is established, the OPI open end can sample the target liquid using the previously registered liquid surface location.

By way of further illustration, with respect to FIG. 1B, in one embodiment the fluid delivered to the fluid delivery conduit of the OPI is switched from a transport liquid to a fluid, such as a gas, which can be utilized for positioning of the open end of the OPI relative to a sample surface. A flow of the fluid is established along a path extending from the fluid delivery conduit to the open end of the OPI and the fluid pressure is monitored at one or more locations along the fluid path. The position of the OPI relative to the sample surface is adjusted until a signature variation in the monitored pressure indicates a target position has been achieved, e.g., contact between the open end of the OPI and the sample surface has been established. The position of the OPI open end relative to the sample surface is registered. The liquid transport flow is re-established through the transport flow path. The liquid transport flow may be initiated subsequent to retraction of the OPI open end from the sample surface. In such a situation, the registered position of the OPI open end can be used to re-establish contact between the OPI open end and the sample surface such that the transport flow withdraws sample from the target. The transport flow moves the sample into the ion source where at least some of it is analyzed by the mass spectrometer.

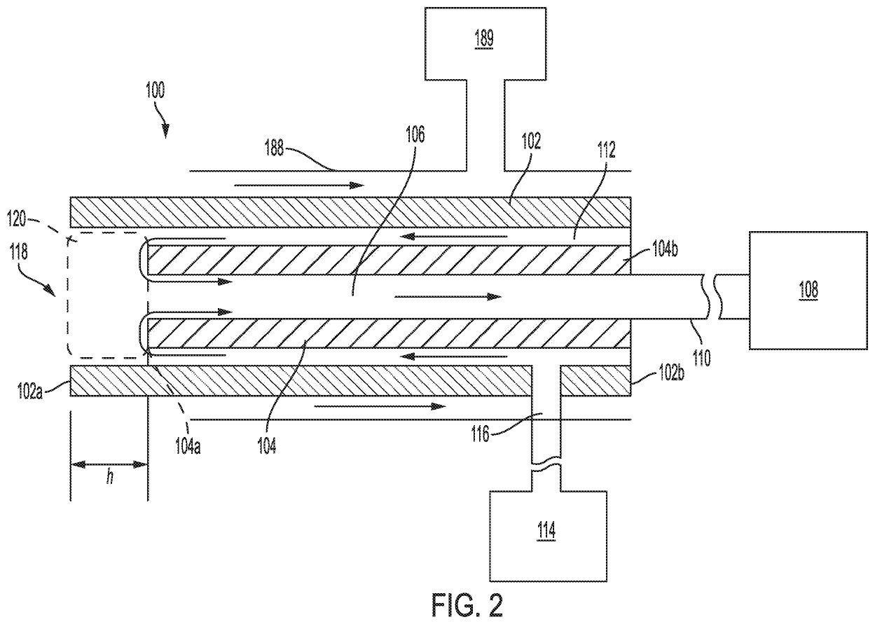

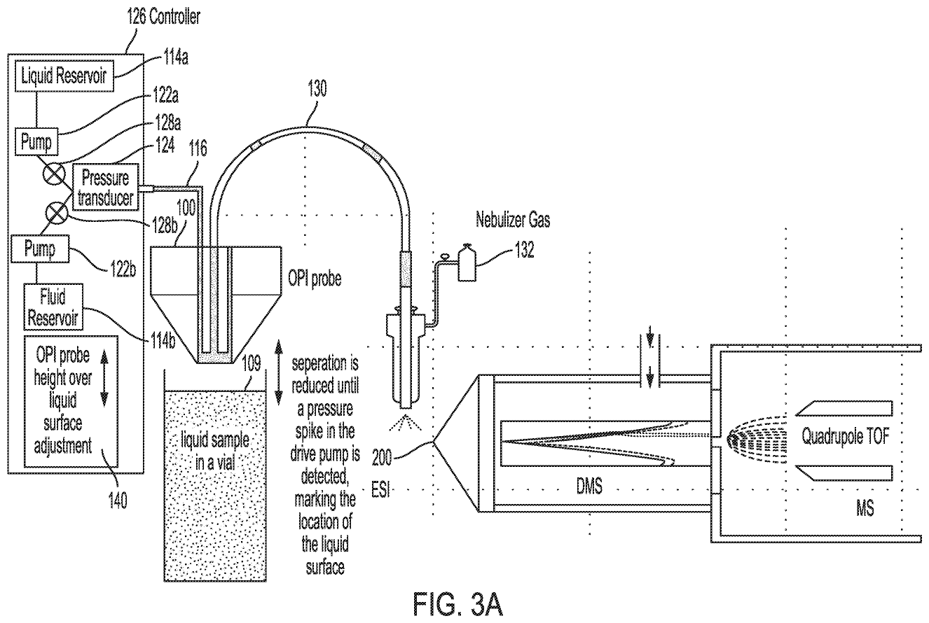

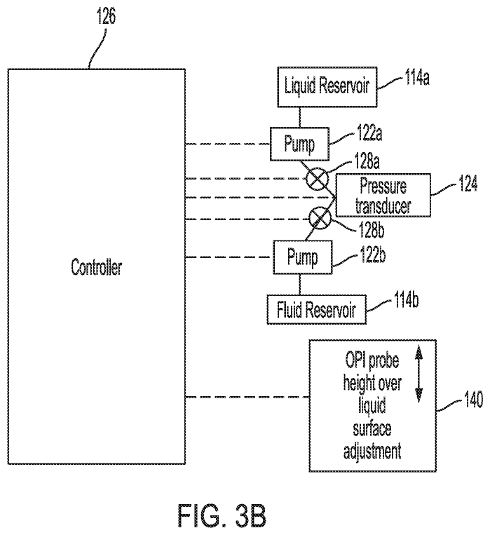

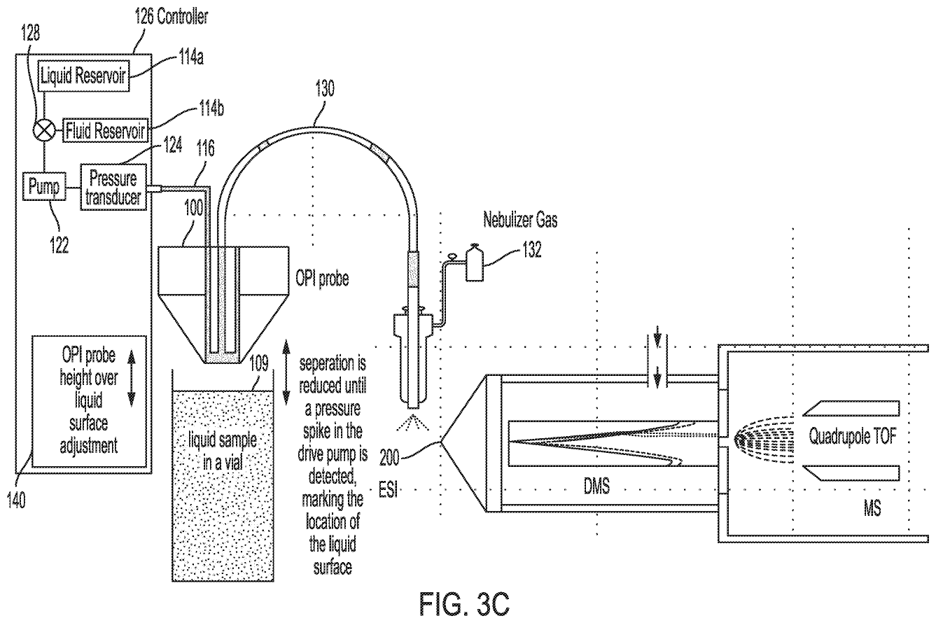

With reference to FIGS. 2 and 3, in one embodiment, an open port interface (OPI) 100 includes an outer tube 102 (e.g., outer capillary tube) extending from a proximal end 102a to a distal end 102b and an inner tube 104 (e.g., inner capillary tube) disposed co-axially within the outer capillary tube 102. As shown, the inner capillary tube 104 also extends from a proximal end 104a to a distal end 104b. The inner capillary tube 104 includes an axial bore providing a fluid channel therethrough, which defines a sampling conduit 106 (herein referred to as the “liquid exhaust conduit”) through which liquid containing a specimen extracted from a sample surface can be transferred to an ion source 108 via an outlet conduit 110.

On the other hand, the annular space between the inner surface of the outer capillary tube 102 and the outer surface of the inner capillary tube 104 can define a fluid delivery conduit 112 extending from an inlet end coupled to a solvent source 114 (herein also referred to as a liquid reservoir), e.g., via the probe inlet conduit 116, to an outlet end (adjacent the distal end 104b of the inner capillary tube 104). The outlet end 118 is herein also referred to as the open end of the OPI interface.

In some exemplary aspects of the present teachings, the proximal end 104a of the inner capillary tube 104 can be recessed relative to the proximal end 102a of the outer capillary tube 102 so as to define a proximal fluid chamber that extends between and is defined by the proximal end 104a of the inner capillary tube 104 and the proximal end 102a of the outer capillary tube 102. Thus, the proximal fluid chamber 120 represents the space adapted to contain fluid between the open proximal end of the OPI interface and the proximal end 102a of the inner capillary tube 102.

Further, as indicated by the arrows of FIG. 2, within the OPI 100, the fluid delivery conduit 112 is in fluid communication with the sampling capillary 106 via this proximal fluid chamber 120. In this manner and depending on the fluid flow rates of the respective channels, fluid that is delivered to the proximal fluid chamber 120 through the fluid delivery conduit 112 can enter the inlet end of the sampling conduit 106 for transmission to its outlet end and subsequently to the ion source 108.

With reference to FIGS. 3A, 3B, and 3C, the solvent source 114a can be fluidly coupled to the fluid delivery conduit 112 via a supply conduit 116 through which solvent can be delivered at a selected volumetric rate via a pump 122a. A variety of pumps can be employed in the practice of the present teachings. Some examples include, without limitation, reciprocating pumps, positive displacement pumps such as rotary, gear, plunger, piston, peristaltic, diaphragm pump, and other pumps such as gravity, impulse and centrifugal pumps, all by way of non-limiting example. The reservoir 114a may contain a variety of fluids though the solvent delivered to the fluid chamber through the fluid delivery conduit 112 is generally amenable to the ionization process.

Similarly, it will be appreciated that one or more pumping mechanisms can be provided for controlling the volumetric flow rate through the sampling conduit 106 and/or the electrospray electrode of the ion source 108. Delivered flow rate through the fluid delivery conduit 112 may be the same or different from the extracted flowrate through the sampling conduit 106. By way of non-limiting example, the volumetric flow rate through the fluid delivery conduit 112 can be temporarily increased relative to the volumetric flow rate through the sampling conduit 106 such that the fluid in the proximal fluid chamber 120 overflows from the open end of the substrate sampling probe 100 to clean any residual sample deposited by the withdrawn substrate and/or to prevent any airborne material from being transmitted into the sampling conduit 106 (e.g., after withdrawal of a substrate, before the insertion of another substrate). In this manner, a difference between the two flowrates may be used to enhance sampling rates during normal OPI operation or to provide cleaning process of the OPI, e.g., where both the internal as well as the external walls of the 102/104 conduits are purged of chemical history. By way of example, the outer wall of the conduit 102 can be rinsed/flushed by direct ejection of the liquid or by wicking action or by wicking action assisted by the wash liquid retraction towards the OPI distal end through conduit 188 to waste.

The flow of the wash liquid through conduit 188 can be in either direction. For example, the wash liquid can be pushed towards the proximal end of the outer conduit 102 by pump 189 and drip to waste or be withdrawn under pull action by the pump 189 to waste. Pump 189 can be replaced by a valve manifold utilizing the pump 122. Without wash extraction towards the OPI distal end, bead formation and drop to waste can be utilized. The conduit 188 can also be used to supply wash liquid that flows over the external wall of the conduit 102 and may flow/drip drop to waste by gravity.

In various aspects, the flow of solvent into the proximal fluid chamber 120 can be terminated and the chamber 120 drained (e.g., by removing solvent therein via the sampling conduit 106 and/or aspiration/ejection through the open end) such that additional fluid such as a second solvent and one or more reagents may be added to the drained proximal fluid chamber while the flow of fluid into and out of the proximal fluid chamber 120 via the fluid delivery conduit 112 or sampling conduit 106 is stopped

With particular reference to FIG. 3A, the flow can be switched from a pump 122a to a pump 122b and deliver fluid (e.g., a gas) from a fluid reservoir 114b via a valve 128b to the fluid delivery conduit 116 for positioning of the OPI open end relative to the sample surface. In some embodiments, the gas can be the air in the ambient environment. In other words, in such a case, the ambient environment can function as the fluid reservoir.

FIG. 3B shows the communication and control links between the controller 126 and pumps 122a,b; valves 128a,b; pressure transducer 124; as well as a “Z” drive that can be used for adjusting the separation between the OPI open end and sample surface.

While FIG. 3A shows a two-pump embodiment, in other embodiments, more than two pumps may be employed, e.g., in applications where additional flows and/or fluids are needed for the detection process and/or sampling process. Alternatively, in other embodiments, a single pump may be employed, as shown schematically in FIG. 3C. In this embodiment, an intake flow into a single pump 122, can be switched by a valve 128 between transport liquid 114a and sensing fluid 114b, e.g., under the control of the controller 126.

It will be appreciated that OPI interfaces in accordance with the present teachings
can have a variety of configurations and sizes, with the OPI of FIGS. 2, 3A, 3B and 3C representing an exemplary depiction. By way of non-limiting example, the dimensions of an inner diameter
of the inner capillary tube 104 can be in a range from about 1 micron to about 1 mm (e.g., 200 microns), with exemplary dimensions of the outer diameter of the inner capillary tube 104 being in a range from about 100 microns to about 3 or 4 centimeters (e.g., 360 microns).

Also by way of example, the dimensions of the inner diameter of the outer capillary tube 102 can be in a range from about 100 microns to about 3 or 4 centimeters (e.g., 450 microns), with the typical dimensions of the outer diameter of the outer capillary tube 102 being in a range from about 150 microns to about 3 or 4 centimeters (e.g., 950 microns). The cross-sectional shapes of the inner capillary tube 104 and/or the outer capillary tube 102 can be circular, elliptical, superelliptical (i.e., shaped like a superellipse), or even polygonal (e.g., square). In one example embodiment, the inner tube 104 may exhibit a circular cross-sectional shape exhibiting an inner diameter of about 250 microns and an outer diameter of about 800 microns, while the outer tube 102 has a circular cross-sectional shape exhibiting an inner diameter of about 950 microns such that a fluid pathway is defined by the annular space between the inner wall of the outer tube 102 and the outer wall of the inner tube 104. Additional details regarding sampling probes suitable for use in the present teachings can be found, for example, in U.S. Pub. No. 20130294971 entitled “Surface Sampling Concentration and Reaction 4277-0270WO01Probe” and U.S. Pub. No. 20140216177 entitled “Method and System for Formation and Withdrawal of a Sample From a Surface to be Analyzed” the teaching of which are hereby incorporated by reference in their entireties.

In this embodiment, a pressure transducer 124 is positioned at the outlet of the pumps 122a,b to measure the pressure of a fluid delivered to the fluid delivery conduit. In some embodiments, the pressure transducer 124 is integrated in the pump. In other embodiments, the pressure transducer can be a stand-alone transducer that is fluidly coupled to the conduit that transports the fluid to the fluid delivery conduit of the OPI interface.

In this embodiment, a controller 126 is in communication with the pumps 122a/122b and the pressure transducer 124 as well as the valves 128a/128b.

Under normal operation of the OPI interface, the pump 122a can supply transport liquid (e.g., a solvent) to the OPI, where the transport liquid flows through the fluid delivery conduit 112 and is received by the sample conduit 106 to be transported to the ion source 108.

In this embodiment, for positioning of the open end of the OPI interface relative to a surface of a sample 109 rather than pumping liquid into the fluid delivery conduit, the pump 122b is utilized to pump air into the fluid delivery conduit such that the air exits the open end of the OPI interface. The flow of air can clear the fluid delivery conduit of any residual liquid and create an “air-over-sample” condition.

As the air is pumped into the OPI interface, the air pressure is monitored via the pressure transducer 124. Once a stable pressure reading is achieved (e.g., a pressure reading that fluctuates by less than 10%), the OPI interface can be moved, e.g., under control of the controller 126 and “Z” translation drive 140, towards the sample surface while the pressure transducer continues to monitor the air pressure. During this operation the flow through 106 may be stopped.

Upon contact of the open end of the OPI interface with the sample surface, the liquid surface presents a blocking resistance to the air flow, which can result in an increase, e.g., in the form of a spike, in the air pressure measured by the pressure transducer.

Such an increase in the monitored pressure can be utilized as a pressure signature indicating that a desired positioning of the open end of the OPI relative to the sample surface has been achieved. By way of example, in some embodiments, a change of more than about 0.01% or 0.1% or 1% or 10% of the monitored pressure prior to contact may signal that a desired positioning of the end of the OPI interface relative to the sample surface has been achieved.

Once a desired position of the end of the OPI interface relative to the sample surface is established, e.g., a contact between the open end of the OPI and the sample surface is established, the normal operation of the OPI for transferring the sample to the ion source may be initiated. For example, in this embodiment, the valve 128b can be closed and the valve 128a can be opened, under the control of the controller 126, to deliver the liquid stored in the liquid reservoir 114a to the fluid delivery conduit of the OPI interface to begin the normal operation of the OPI interface for introduction of the sample into the OPI interface, and more specifically into the liquid exhaust conduit of the OPI interface. The sample will be entrained in the liquid flow and will be transported via a sample transport conduit 130 to the ion source in which the sample, or at least a portion thereof, undergoes ionization, thereby generating a plurality of ions. The flow of the liquid sample through the sample transport conduit 130 is facilitated by a Venturi pressure drop created by the flow of a nebulizer gas supplied by a gas source 132 past the distal end of the sample transport conduit. During sample surface detection process the flow through the conduit 106 may be stopped, e.g., by turning off or diverting the nebulizer gas flow causing the Venturi pull through the conduit 106.

The ions are introduced into the mass spectrometer via an orifice thereof for mass analysis.

As noted above, the controller 126 can control the movement of the OPI interface relative to the sample surface. Further, the controller 126 can be in communication with the pressure transducer 124 to receive pressure measurements generated by the transducer and process the pressure measurements to identify the pressure signature (i.e., a pressure spike) associated with the desired positioning of the open end of the OPI relative to the sample surface, e.g., to identify the contact of the open end of the OPI with the sample surface.

In this embodiment, once the controller 126 identifies the establishment of contact between the open end of the OPI and the sample surface, the controller can cause the opening of the valve 128a to allow introduction of the liquid from the liquid reservoir 114a, under the influence of the pump 122a, into the fluid delivery conduit. Once the sample is registered, the controller can also initiate a set of steps to achieve steady transport liquid flow through the OPI prior to re-introduction of the OPI into the sample. For example, the controller can cause the retraction of the OPI open end from the sample surface followed by initiating the flow of the transport liquid into the OPI. The controller can then utilize the registered position of the OPI corresponding to the existence of contact between the OPI open end and the sample surface to re-establish contact between the OPI open end and the sample surface for extracting the sample into the OPI.

As discussed above, in various embodiments, a single pump, two pumps, or more than two pumps may be utilized in the practice of the present teachings. For example, a single pump and an appropriate valve manifold can be implemented, e.g., in a manner discussed above, to provide the dual functions of introducing a fluid into the OPI for detecting contact between the open end of the OPI and a sample surface and for introducing a transport liquid into the OPI for extraction of the sample into the OPI. Further, in some embodiments, a “pull” flow mode can be used for generating fluid flow through the fluid path for the detection of contact between the OPI open end and the sample surface. When pull rather than push flow is utilized the flow direction of the fluid through the OPI is reversed. The flow through the conduit 106 can be stopped during the detection of the sample surface.

In some embodiments, subsequent to identifying a contact between the open end of the OPI and the sample surface, the position of the open end of the OPI (e.g., its height (here Z-dimension) relative to the sample surface) can be recorded and the OPI can be retracted from the sample surface. After establishing a liquid flow through the OPI interface, the OPI can again be moved into contact with the sample surface using the fiducial position of the OPI determined via the pressure signature.

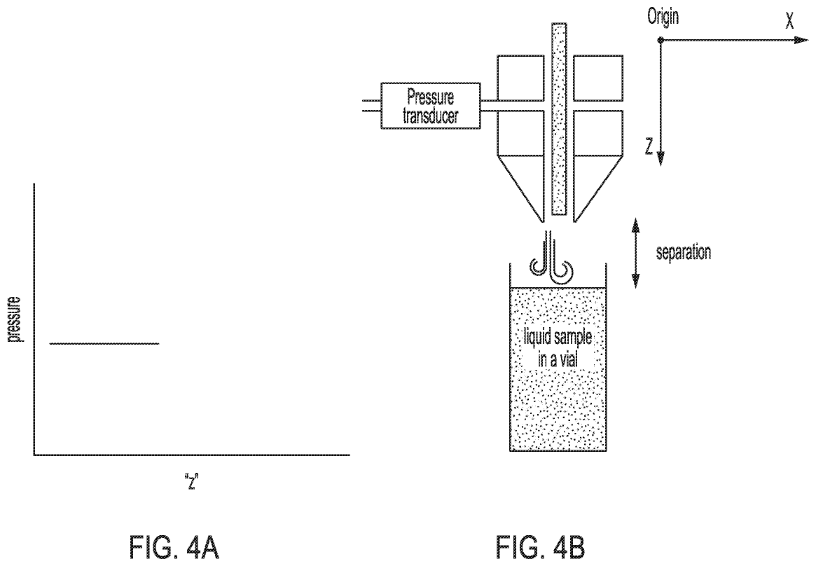

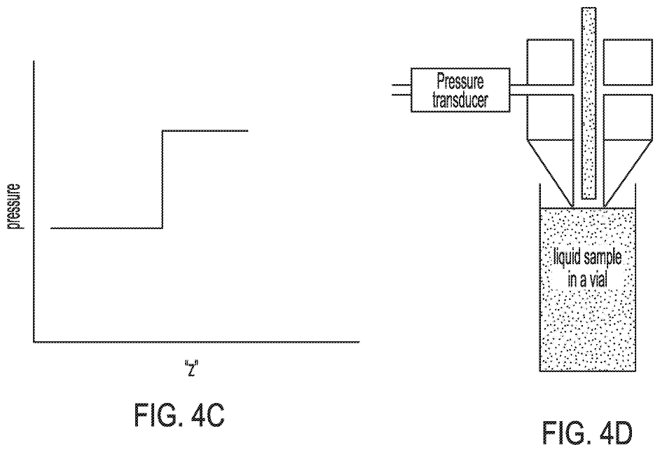

With reference to FIGS. 4A and 4B, a Cartesian coordinate system with an arbitrary origin can be established, where the origin of the coordinate system is above the liquid surface and the vertical distance is measured along the Z axis such that as Z increases the separation between the open end of the OPI and the liquid surface decreases. Prior to contact of the open end of the OPI with the liquid surface, the measured pressure remains steady as the open end of the OPI is moved closer to the liquid surface. As shown schematically in FIGS. 4C and 4D, upon contact between the open end of the OPI and the liquid surface, an increase in the measured pressure is observed. In some embodiments, upon detecting contact between the open end of the OPI and the liquid surface, the position of the open end of the OPI along the Z direction is registered and the open end of the OPI is retraced from the liquid surface. A flow of the solvent to the OPI can be initiated and the open end of the OPI can be brought in contact with the liquid surface using the previously-registered position of the open end of the OPI.

With particular reference to FIGS. 3A and 3C, in this embodiment, the OPI can deliver the sample to an electrospray ionization (ESI) source, which ionizes the sample to generate a plurality of ions. The ions are then received via an orifice 200 of the mass spectrometer to undergo mass analysis. A variety of different mass spectrometers may be employed. By way of illustration, and without limitation, in this embodiment, the mass spectrometer includes a differential mobility mass spectrometer (DMS), which is positioned upstream relative to a hybrid quadrupole-time-of-flight (TOF) mass analyzer. In other embodiments, other types of mass spectrometers can be utilized.

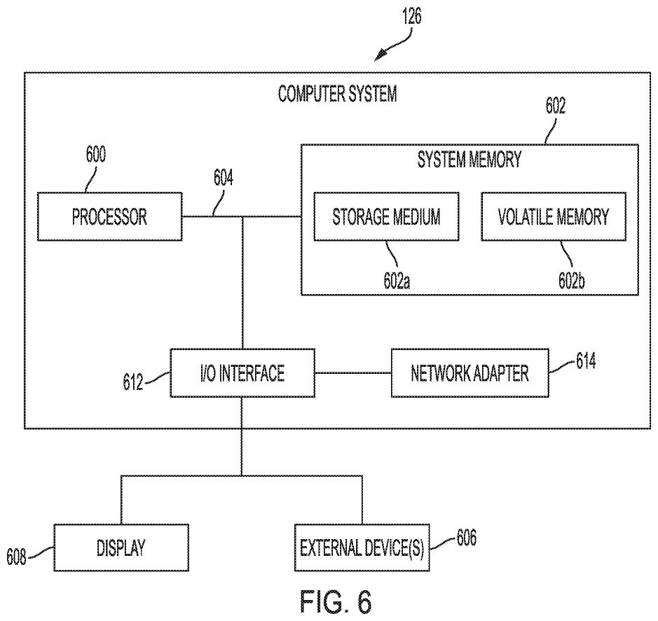

The controller 126 can be implemented in hardware, firmware and/or software using techniques known in the art as informed by the present teachings. By way of example, FIG. 6 schematically depicts an example of such implementation.

As shown in FIG. 6, the controller 126 can include one or more processors or processing units 600, a system memory 602, and a bus 604 that allows communication between various components of the controller including the system memory 602 to the processor 600.

The system memory 602 includes a computer readable storage medium 602a and volatile memory 602b (e.g., Random Access Memory, cache, etc.). As used herein, a computer readable storage medium includes any media that is capable of storing computer readable program instructions and is accessible by a computer system. The computer readable storage medium 602a includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the controller 126) to function in a particular manner such that a computer readable storage medium comprises an article of manufacture. Specifically, when the computer readable program instructions stored in the computer readable storage medium 602a are executed by the processor 600, they create means for implementing the functions specified in the present teachings. For example, the instructions can include comparing pressure readings generated by the pressure transducer with respect to a predefined pressure to identify a pressure spike indicative of the establishment of contact between the OPI open end and the sample surface. Further, instructions for moving the OPI relative to the sample surface can be stored on the computer readable storage medium.

The bus 604 may be one or more of any type of bus structure capable of transmitting data between components of the controller (e.g., a memory bus, a memory controller, a peripheral bus, an accelerated graphics port, etc.).

In some embodiments the controller 126 may include one or more external devices 606 and a display 608. As used herein, an external device includes any device that allows a user to interact with the controller (e.g., mouse, keyboard, touch screen, etc.). The external devices 606 and the display 610 are in communication with the processor 600 and the system memory 602 via an Input/Output (I/O) interface 612. In some embodiments, the controller can further include a network adapter 614 to allow establishing communication between the controller and other devices.

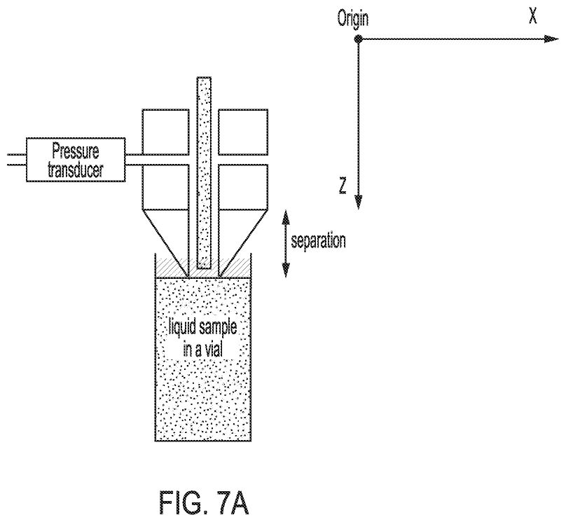

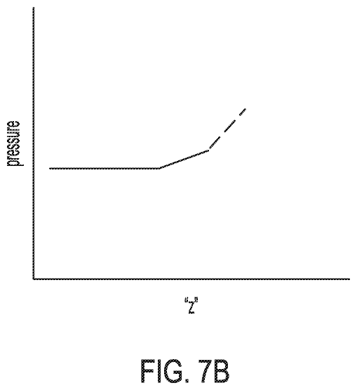

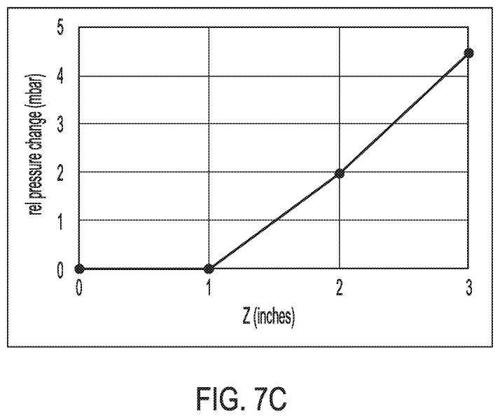

In some embodiments, the methods and systems disclosed herein can be utilized for not only detecting the surface of a liquid sample but also detecting liquid-liquid interfaces at a depth below the sample liquid surface. For example, with reference to FIG. 7A, subsequent to the detection of contact between the open end of the OPI and the liquid sample/air interface in a manner discussed above via the detection of a change in the monitored pressure, the open end of the OPI can be moved deeper into the liquid sample while the flow of the air out of the open end of the OPI is maintained so as to detect an interface (a boundary), if any, between the upper layer of the liquid and a different liquid layer, which is immiscible with the upper liquid layer and is positioned below the upper liquid layer. The detection of the different liquid layer, if any, below the upper liquid layer can be achieved via detection of another pressure change as the open end of the OPI reaches the interface between the two liquid layers. The position of the open end of the OPI can then be adjusted, e.g., moving the open end of the OPI up or down, to withdraw a sample from either liquid layer. In this manner, liquid-liquid extraction can be achieved via an automatic detection of the liquid boundaries, adjusting the position of the open end of the OPI, and withdrawing sample(s) from a target liquid layer.

By way of further illustration, FIG. 7B shows a hypothetical example of a change in the monitored pressure as the open end of the OPI is lowered into the liquid. The solid rising line indicates the transit of the open end of the OPI through the top liquid layer with the positive slope indicating that the monitored pressure increases with depth. The dashed line rising at a steeper angle indicates the probe tip entering the lower liquid layer and proceeding down. Since the lower layer is “heavier” (that is, it has a higher density than the top liquid layer), and hence it is located below the top layer, it would be safe to assume that the pressure would increase as the open end of the OPI enters the lower liquid layer, though there might be situations in which the slope of the monitored pressure may decrease as the open end of the OPI enters the lower liquid layer. Thus, in some embodiments, a change in the slope of pressure as the open end of the OPI is lowered into the liquid can indicate the detection of a liquid-liquid boundary layer.

As noted above, the present teachings for identifying liquid-liquid interfaces can be used to identify multiple liquid/liquid boundaries (interfaces) of immiscible liquid layers. For example, when there is a sufficient difference between the densities of various liquid layers stacked on top of each other, the monitored pressure of the gas exiting the open end of the OPI can be utilized to distinguish one liquid layer from another. By way of further illustration, FIG. 7C shows an example of the variations in the monitored pressure that may be observed when the open end of the OPI is moved through 1 inch of air (0.002 mbar/in) to reach and traverse one-inch layer of methanol (1.97 mbar/in) and to finally reach and traverse a one-inch layer of water (2.49 mbar/in).

Some examples of different liquid layers can include, without limitation, aqueous/organic layers. By way of example, the organic layer can be any of hexane, ethyl acetate, and pentanol, all by way of example. For example, the organic layer can be on top of the aqueous layer. In another example, the two layers can include an aqueous layer that is positioned below a dichloromethane layer.

In other cases, the sample may include more than two different immiscible liquid layers, e.g., three layers stacked on top of each other. In such cases, the same process can be repeated by moving the open end of the OPI deeper into the sample, subsequent to the detection of the first liquid-liquid boundary, to detect other liquid-liquid boundaries. In some embodiments, upon detection of each liquid-liquid boundary, the position of the boundary can be registered, e.g., using a coordinate system established in the laboratory. The open end of the OPI can be retracted from the sample, the flow of the solvent through the OPI can be established, and the registered positions of the liquid-liquid boundaries can then be utilized to reach a liquid layer of interest for sampling. Such an approach can allow sampling multi-phase liquid samples, e.g., samples having highly aqueous liquid layers, intermediate polarity liquid layers, and highly non-polar liquid layers. In other words, such an approach allows liquid-liquid extraction of multi-phase liquid samples.

The following Example is provided for further elucidation of various aspects of the present teachings and is not provided to illustrate necessarily optimal ways of practicing the present teachings and/or optimal results that may be obtained.

### Example

In some embodiments, a dual-function liquid pump can be used in performing a method according to the present teachings for positioning an OPI interface relative to a sample surface. Such a dual-function liquid pump can include microchip pressure transducers and gas pressure amplifiers. The dual-function liquid pump can serve two purposes: (1) it can provide the OPI with a continuous pulse free solvent flow that can deliver the sample to an ion source, e.g., a conventional ESI (electrospray ion) source. By way of example, the fluid can be pumped via gas pressure generated by piezo-driven blowers that pressurize ambient air; (2) the pump can serve to sense contact between the OPI and the sample surface. An on-board microprocessor pressure transducer can be used to detect a pressure change when contact between the end of the OPI and the sample surface is made.

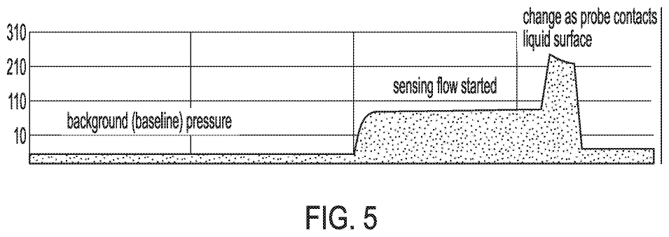

By way of further illustration, FIG. 5 shows background baseline pressure prior to initiating flow of a gas into the fluid delivery conduit of the OPI interface for sensing the position of the open end of the OPI relative to a sample surface. The initiation of the sensing gas flow through the OPI can result in an increase in pressure, which remains substantially stable until contact is made between the open end of the OPI and the sample surface. As shown in the illustrative diagram, and without being bound to any particular theory, once the open end of the OPI contacts the sample surface, the surface tension at the liquid-gas interface presents a resistance to the air flow and hence creates a pressure spike indicative of contact between the open end of the OPI and the sample surface.

The pressure transducer of the pump measures this pressure variation directly. As discussed above, the pressure change can then be utilized to detect liquid/air interface when positioning the open end of the OPI relative to the sample surface.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

What is claimed is:

1. A method of positioning an open end of an open port interface (OPI) relative to a sample surface to be analyzed by mass spectrometry, wherein the OPI comprises a fluid delivery conduit for delivering a fluid to the open end of the OPI and a liquid exhaust conduit for removing liquid from the open end of the OPI, the method comprising:
establishing a fluid flow along a path extending from the fluid delivery conduit to said open end of the OPI,
monitoring fluid pressure at one or more locations along said fluid flow path, and
adjusting a position of the open end of the OPI relative to the sample surface based on said monitored fluid pressure.

2. The method of claim 1, wherein said fluid comprises any of a gas and a liquid.

3. The method of claim 1, further comprising identifying a target position of the open end of the OPI relative to the sample surface via identification of a predefined pressure variation in said monitored fluid pressure.

4. The method of claim 1, wherein said sample surface is any of a liquid surface and a solid surface.

5. The method of claim 1, further comprising utilizing a pump for establishing said fluid flow.

6. The method of claim 5, wherein said fluid pressure is measured at an outlet port of said pump.

7. The method of claim 5, wherein said pump comprises a pressure transducer for measuring said fluid pressure.

8. The method of claim 1, wherein the step of adjusting the position of the open end of the OPI relative to the sample surface comprises adjusting a distance between the open end of the OPI and the sample surface.

9. The method of claim 2, wherein said predefined pressure variation includes any of a predefined increase and a predefined decrease in the monitored fluid pressure.

10. A method of operating a dual-function open port interface (OPI) used in mass spectrometry, wherein said OPI includes a fluid delivery conduit for delivering a fluid to an open end thereof, and a liquid exhaust conduit for removing liquid from the open end, the method comprising:
operating the OPI in a sample-positioning mode by establishing a fluid flow along a path extending from the fluid delivery conduit to the open end of the OPI,
monitoring fluid pressure at one or more locations along said fluid flow path, and
identifying contact between the open end of the OPI and a sample surface by detecting a pressure variation in said monitored fluid pressure,
subsequently, switching operation of the OPI into a sample-collection mode by establishing a flow of a transport liquid into said fluid delivery conduit for introducing one or more portions of the sample into the liquid exhaust conduit.

11. The method of claim 10, further comprising registering a position of said open end of the OPI upon establishing contact between the open end of the OPI and the sample surface.

12. The method of claim 11, further comprising retracting said open end from the sample surface subsequent to said step of registering the position of said open end.

13. The method of claim 12, wherein said step of switching the operation of the OPI is performed subsequent to said retracting step.

14. The method of claim 11, further comprising utilizing said registered position of the open end of the OPI for re-establishing contact between the open end of the OPI and the sample surface subsequent to said step of switching the operation of the OPI.

15. The method of claim 14, further comprising utilizing the transport liquid to wash one or more surfaces of any of said fluid delivery conduit and said liquid exhaust conduit.

16. The method of claim 15, wherein said step of utilizing the transport liquid to wash said one or more surfaces is performed prior to said step of re-establishing contact.

17. A mass spectrometer, comprising:
an open port interface (OPI) having a dual-mode functionality such that in one mode the OPI can be utilized for establishing contact between an open end thereof and a sample surface and in another mode the OPI can be utilized for collecting the sample at an open end thereof, wherein said OPI is movable relative to a surface of said specimen and wherein said OPI includes a fluid delivery conduit for delivering a fluid to the open end of the OPI and a liquid exhaust conduit for removing liquid from the open end of the OPI,
a pump for establishing a fluid flow along a path extending from the liquid delivery conduit to said open end of the OPI,
a pressure transducer for monitoring fluid pressure at one or more locations along said fluid flow path and generating pressure measurement data, and
a controller for receiving the pressure measurement data and processing the pressure measurement data to identify a desired position of the open end of the OPI relative to the sample surface.

18. The mass spectrometer of claim 17, wherein the controller is configured to identify said desired position via detection of a pressure increase in said pressure measurement data.

19. The mass spectrometer of claim 18, wherein said pressure increase is in a range of about 0.01% to about 10% of a pressure measured prior to contact between said open end of the OPI and said sample surface.

20. The mass spectrometer of claim 17, further comprising a reservoir for storing the liquid.
